(19) United States
(12) Patent Application Publication
(10) Pub. No.: US 2026/0244788 A1
(43) Pub. Date: Aug. 20, 2026

(54) SYSTEMS AND METHODS FOR PROTECTING BYSTANDER VISUAL DATA IN AUGMENTED REALITY SYSTEMS

(71) Applicants: VIRGINIA TECH INTELLECTUAL PROPERTIES, INC., Blacksburg, VA (US); PURDUE RESEARCH FOUNDATION, WEST LAFAYETTE, IN (US); MONTCLAIR STATE UNIVERSITY, Montclair, NJ (US)

(72) Inventors: Matthew Corbett, Christiansburg, VA (US); Brendan Matthew David- John, Blacksburg, VA (US); Jiacheng Shang, Secaucus, NJ (US); Yu Charlie Hu, Lafayette, IN (US); Bo Ji, Blacksburg, VA (US)

(21) Appl. No.: 19/472,334

(22) PCT Filed: Apr. 4, 2024
(86) PCT No.: PCT/US2024/023077

§ 371 Date: Oct. 3, 2025

Related U.S. Application Data
(60) Provisional application No. 63/494,336, filed on Apr. 5, 2023.

(51) Int. Cl. G06F 21/62; G06F 3/01; G06V 20/20; G06V 40/16; G10L 25/57

(52) U.S. Cl. CPC G06F 21/6254; G06F 3/013; G06V 20/20; G06V 40/172; G10L 25/57

(57) ABSTRACT

Embodiments of the present disclosure introduce approaches for protecting bystander privacy in a wearable augmented reality (AR) device. In one embodiment, a video frame is captured via a camera of the wearable AR device, and faces are detected in the video frame. A first face is classified as a subject based at least in part on eye gaze tracking of a user of the wearable AR device by an eye gaze sensor of the wearable AR device. A second face is classified as a bystander based at least in part on the eye gaze tracking of the user. The second face is obscured in the video frame in response to the second face being classified as the bystander.

### CROSS-REFERENCE TO RELATED APPLICATIONS

This application claims priority to U.S. Provisional Application No. 63/494,336, entitled “SYSTEMS AND METHODS FOR PROTECTING BYSTANDER VISUAL DATA IN AUGMENTED REALITY SYSTEMS,” and filed on Apr. 5, 2023, which is incorporated herein by reference in its entirety.

### GOVERNMENT LICENSE RIGHTS

This invention was made with government support under grant number 2112778 awarded by the National Science Foundation (NSF). The government has certain rights in the invention.

### BACKGROUND

Augmented Reality (AR) devices are expected to reach an estimated 1.7 billion users by 2024, expanding from 1 billion in 2022. This is driven in part by industrial, healthcare, automotive, and military applications, with AR devices creating advances in mental health research, military decision-making, and assisting students with disabilities. These applications rely on the unique capabilities of AR devices, namely the ability to understand the physical world, and seamlessly blend the physical world and the holographic, digital world. This ability to create a virtual mapping of a physical space through Simultaneous Localization and Mapping (SLAM), establish synthetic holographic contact, and sense user eye gaze and hand gestures, is made possible by the integrated and powerful suite of sensors on modern AR devices. These sensors include Visible Light Cameras (VLCs), depth sensors, infrared sensors, eye-tracking sensors, embedded microphones, accelerometers, and more.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method for protecting bystander privacy in a wearable augmented reality (AR) device. The computer-implemented method also includes capturing a video frame via a camera of the wearable AR device. The method also includes detecting a plurality of faces in the video frame. The method also includes classifying a first face of the plurality of faces as a subject based at least in part on eye gaze tracking of a user of the wearable AR device by an eye gaze sensor of the wearable AR device. The method also includes classifying a second face of the plurality of faces as a bystander based at least in part on the eye gaze tracking of the user. The method also includes obscuring the second face in the video frame in response to the second face being classified as the bystander. Other embodiments of this aspect include corresponding computer systems, apparatus, and computer programs recorded on one or more computer storage devices, each configured to perform the actions of the methods.

Implementations may include one or more of the following features. The computer-implemented method may include releasing the video frame where the second face is obscured to an application requesting the video frame. The first face is classified as the subject further based at least in part on whether the audio indicates that the user is speaking. The second face is classified as the bystander further based at least in part on whether the user is speaking. Classifying the first face as the subject is further based at least in part on an eye gaze history of the user directed at the first face meeting a threshold. Classifying the second face as the bystander is further based at least in part on an eye gaze history of the user directed at the second face not meeting a threshold. The computer-implemented method may include preventing an application executed in the wearable AR device from accessing the video frame prior to obscuring the second face in the video frame. Classifying the first face as the subject is further based at least in part on an eye gaze history of the user directed at the first face and a simultaneous voice contact of the user meeting a first threshold, the first threshold being lower than a second threshold associated with the eye gaze history but not the simultaneous voice contact. The computer-implemented method may include reclassifying the first face as the bystander in a subsequent video frame based at least in part on the eye gaze tracking relative to the subsequent video frame. The computer-implemented method may include reclassifying the second face as the subject in a subsequent video frame based at least in part on the eye gaze tracking relative to the subsequent video frame. Detecting the plurality of faces in the video frame further may include determining a respective three-dimensional bounding box around individual ones of the plurality of faces. The computer-implemented method may include tracking movement of the plurality of faces in a subsequent video frame based at least in part on the respective three-dimensional bounding box around the individual ones of the plurality of faces. Obscuring the second face in the video frame further may include obscuring the second face in corresponding depth data based at least in part on plateauing the corresponding depth data using a depth value from an edge of an area including the second face. Obscuring the second face in the video frame further may include completely masking an area of the video frame surrounding the second face. Implementations of the described techniques may include hardware, a method or process, or computer software on a computer-accessible medium.

One general aspect includes a wearable augmented reality (AR) device. The wearable augmented reality also includes a camera. The reality also includes an eye gaze sensor. The reality also includes a processor configured to at least: capture a video frame via the camera, detect a plurality of faces in the video frame, classify a first face of the plurality of faces as a subject based at least in part on eye gaze tracking of a user of the wearable AR device by the eye gaze sensor, classify a second face of the plurality of faces as a bystander based at least in part on the eye gaze tracking of the user, and obscure the second face in the video frame in response to the second face being classified as the bystander. Other embodiments of this aspect include corresponding computer systems, apparatus, and computer programs recorded on one or more computer storage devices, each configured to perform the actions of the methods.

Implementations may include one or more of the following features. The wearable AR device may include a microphone, where the processor is further configured to at least: capture audio associated with the video frame via the microphone; detect a voice in the audio; and classify the first face as the subject based at least in part on the voice detected in the audio. The processor is further configured to at least: prevent an application from accessing the video frame before the second face has been obscured; and release the video frame to the application after the second face has been obscured. The first face is classified as the subject in response to an eye gaze history of the user directed at the first face meeting a first threshold, and the second face is classified as the bystander in response to the eye gaze history of the user directed at the second face not meeting the first threshold and not meeting a second threshold that is lower than the first threshold, the second threshold being evaluated relative to a combination of the eye gaze history of the user and a voice interaction history of the user. The processor is further configured to at least obscure the second face in corresponding depth data based at least in part on plateauing the corresponding depth data using a depth value from an edge of an area including the second face. The processor is further configured to at least track movement of the plurality of faces in a subsequent video frame based at least in part on a respective three-dimensional bounding box around individual ones of the plurality of faces. Implementations of the described techniques may include hardware, a method or process, or computer software on a computer-accessible medium.

One general aspect includes a non-transitory computer-readable medium embodying instructions executable in a processor of a wearable augmented reality (AR) device. The instructions also include capturing a video frame via a camera of the wearable AR device. The instructions also include detecting a plurality of faces in the video frame. The instructions also include classifying a first face of the plurality of faces as a subject based at least in part on eye gaze tracking of a user of the wearable AR device by an eye gaze sensor of the wearable AR device. The instructions also include classifying a second face of the plurality of faces as a bystander based at least in part on the eye gaze tracking of the user. The instructions also include obscuring the second face in the video frame in response to the second face being classified as the bystander. Other embodiments of this aspect include corresponding computer systems, apparatus, and computer programs recorded on one or more computer storage devices, each configured to perform the actions of the methods.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is an illustration showing one use case of AR where bystanders should be protected.

FIG. 2 is an illustration showing the use of a bystander protection system to prevent malicious AR applications from requesting bystander visual data.

FIG. 3 is an illustration showing the two-dimensional to three-dimensional camera-to-world transformation process according to one or more embodiments of the present disclosure.

FIG. 4 is an illustration of one example architecture for a bystander protection system according to one or more embodiments of the present disclosure.

FIG. 5 is an illustration of an output of one implementation of the bystander protection system if a third-party application is requesting visual data.

FIGS. 6A and 6B illustrate the tradeoff in bystander privacy protection between two groups of eye gaze and voice thresholds according to various embodiments of the present disclosure.

FIG. 7 illustrates bystander protection rates of one example implementation of the bystander protection system.

FIG. 8 is a flowchart illustrating the operation of one example of the bystander protection system according to one or more embodiments of the present disclosure.

### DETAILED DESCRIPTION

The present application relates to protecting bystander visual data in AR systems. AR device sensors, while essential to the immersive experience that makes AR devices unique and powerful, do not discriminate in the data they collect. AR devices capture data that is required for well-intentioned tasks (e.g., SLAM, pose estimation, and gesture recognition), but also capture visual data (e.g., camera and depth) or thermal data about bystanders (i.e., persons surrounding the device during its use), which can potentially be used to identify sensitive information (age, gender, ethnicity, emotion, gait, weight, etc.) of bystanders for malicious purposes. Such hidden operations make the bystander privacy leak a viable threat. Even well-meaning users, using AR applications for well-intentioned purposes, can unintentionally violate bystander privacy. This threat of bystander data leak is called the bystander privacy problem.

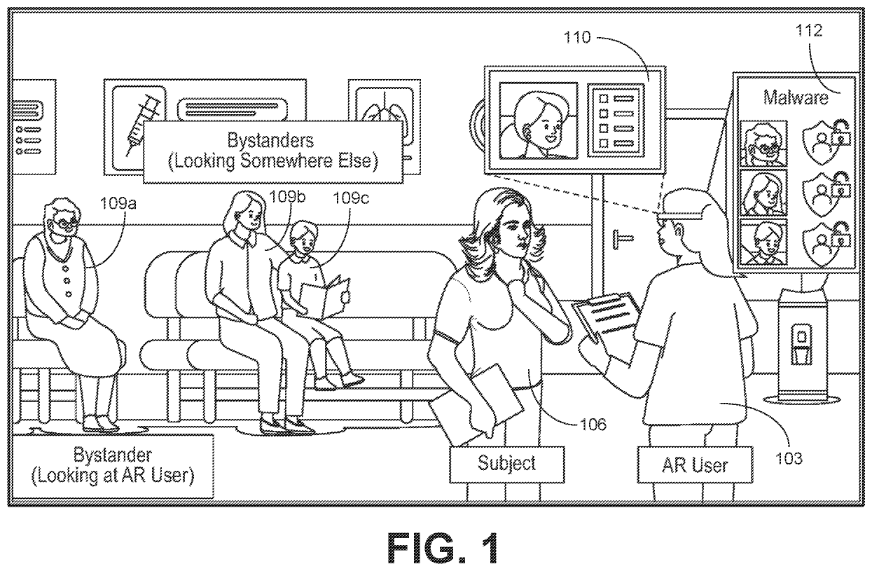

FIG. 1 is an illustration showing the medical use case of AR, where a nurse 103 wearing an AR device is interacting with a patient 106 while there are bystanders 109a, 109b, 109c present. Bystander 109a is looking at the nurse 103, but bystanders 109b and 109c are looking elsewhere. In this situation, while the patient 106 needs to be identified with her medical record information 110 presented to the nurse 103 via the AR device, bystander data and information about bystanders 109 must be protected from use by malware 112.

Example scenarios where the bystander privacy problem can arise include so-called “life-logging” or recording of visual evidence of everyday activities, the video and audio recording from “smart-home” devices, and the AR functionality required to understand and interact with the physical world. Additionally, consider a scenario where a patient in a mental care facility needs assistance with remembering the names of loved ones and caregivers or a medical service scenario, where an AR application is employed to assist nursing staff with triage at a hospital. The AR application may use facial recognition to present the patient or nurse with a medical record chart for a patient or a name prompt for a loved one, displayed in the AR device. In the triage scenario as shown in FIG. 1, a patient 106 may be accompanied by a family member who sits or stands near her during a visit, and there could be other nearby patients as well. In both these situations, the AR application may identify the faces of the bystanders 109 (i.e., her family member and other patients) and unintentionally retrieve and present their medical records or identity information.

Bystander privacy protection (BPP) systems for mobile and wearable devices in general can be divided into two categories based on whether the required input is explicit or implicit. Explicit BPP systems require the bystander or the user to possess an item, perform a gesture, or enroll in a system to expect privacy protection, which is not desired. In contrast, by using implicit information about the bystander (e.g., distance from the camera, the direction of eye gaze, emotion, and position in the frame) to determine if she is meant to be a part of the captured image, implicit BPP systems seek to protect bystander privacy even when the bystander is unaware of the presence of the device. However, such systems can perform poorly in bystander detection when bystanders do not present themselves as expected in the captured image. In addition, existing implicit systems are implemented exclusively off-device, meaning that bystander data must be transferred to another node for processing. This opens an additional attack surface during the movement of this unprotected bystander data to a remote location.

Various embodiments of the present disclosure introduce a BPP system for head-worn AR devices. The AR device user's eye gaze and voice is a highly effective indicator for subject/bystander determination in interpersonal interaction. Accordingly, various embodiments use the AR user's eye gaze and voice data to accurately determine the subject of an AR interaction, by leveraging novel AR capabilities such as eye gaze tracking and a microphone array directed toward the AR device wearer. Various embodiments also address challenges such as that the AR device user's eye gaze may wander off of the subject during the interaction, and that performing the tasks of bystander protection (namely, face detection, eye gaze tracking, subject identification via face-eye-gaze matching, and obscuration of bystanders) for every frame on the AR device may be too costly and infeasible to keep up with the frame rate. To address these challenges, various embodiments leverage functionality of AR devices, namely spatial awareness and eye gaze tracking, to locate faces in 3D and monitor the user's interactions with the detected face, hence removing the need to infer the location of faces from every captured frame and maintaining a usable frame rate with on-device processing.

In an evaluation involving sixteen participants, one implementation was successful in protecting 98.14% of bystander faces through obscuration and in identifying the subject of an AR interaction in 96.27% of output frames. This ensures that the visual data of identified subjects remain available for legitimate uses. The evaluation also shows an improvement in bystander protection by 12%. These improvements are gained while keeping bystander data on-device, removing the need to offload unprotected bystander data to another device. Meanwhile, frame rates are maintained as high as 52.6 frames per second (FPS). Frame rates such as this prevent a negative impact on the AR user's experience while maintaining bystander expectations of privacy.

An AR user (or simply user) is a person who wears an AR device; a subject is a person with whom the user intends to interact; a bystander is any non-user, non-subject third-party surrounding the device during its use. The Bystander Privacy problem refers to the sensitive data leak when a device with sensing capabilities collects data (images, video, audio, etc.) that can potentially be used to identify sensitive information (age, ethnicity, physical disability, emotion, etc.) of bystanders who have not given consent to be part of the data collection. Such bystander data leaks could also happen when well-meaning users, using AR applications for well-intentioned purposes, unintentionally violate bystander privacy. FIG. 1 provides an illustration of the bystander privacy problem in an AR-assisted medical service scenario.

Research into ways that bystander data can be improperly used have confirmed the privacy concerns shown in various focus group studies and surveys. Hidden operations describe a third-party application developer's ability to use machine learning techniques and make malicious inferences about the user's environment without the user's knowledge. These are made possible when users fail to understand or misinterpret overly broad permission requests. Additionally, the permission request approach to protect sensor data is flawed: colluding apps can trick the user into providing access for an app that seems appropriate, and then share sensitive data with restricted apps using a covert channel.

Surveys of bystander attitudes toward the presence of digital communication devices show negative perceptions of cellphone use in public places. The survey participants reported that strangers felt “intruded upon”′ when these devices breach the physical/digital barrier in their presence. The rise of modern mobile devices such as AR devices, opens the door to the development and growing adoption of novel immersible applications such as AR. These applications perform continuous sampling and recording of the physical world as part of their inherent operations, and in doing so, have propelled the bystander privacy problem into prominence. For example, a recent study focused on bystander perception of AR devices shows that bystanders are concerned with data collected by AR devices being used to uniquely identify them, and would prefer a way to require permission for the data to be recorded. Even medically assistive devices, including those designed to help persons with visual impairments, have been shown to elicit negative bystander feedback. On the other hand, bystanders are more willing to allow visual data to be captured if a blurring filter is added during capture; an additional 17.5% stated that they were willing over the un-blurred baseline. Hence, various embodiments of the present disclosure effectively protect bystander privacy without sacrificing the immersive experience AR devices offer.

Explicit BPP systems require either the bystander, the device user, or both to perform some explicit actions to ensure bystander privacy. In some examples, potential bystanders upload photos of their face to train a facial classifier or respond to a prompt on their mobile device after a nearby photo capture to achieve some measure of privacy. Some examples require bystanders to have a pre-defined privacy policy and facial signature on a linked server and potentially require a device user to audit and validate the privacy filters applied to scenarios that the system deems sensitive. Some examples require special equipment to be worn by bystanders or by the device user in the presence of bystanders. Some examples require explicit hand gestures for the bystander to express their privacy preferences, again requiring a bystander to make a conscious decision to be included or not.

In general, by giving the bystander or the user control of the situation, such explicit BPP systems potentially provide the kind of assurances that allow AR devices to be more acceptable in public places. However, requiring the bystander/user to perform explicit actions such as hand gestures or wear special physical devices imposes a significant burden on the user/bystander, resulting in such required actions being overridden, ignored, or unused if the user/bystander is not paying enough attention. Furthermore, such systems often require the device to be connected to a server that acts as the central location for information synthesis and privacy policy enforcement. This not only demands extra network and server support, but also requires raw data to be transferred off the device, which drastically increases the exposure of the data to potential misuse that the system is designed to prevent.

Implicit BPP systems seek to protect bystander privacy without requiring any explicit actions to be taken by the user or the bystander. Such systems may use a machine learning (ML) model (e.g., a neural network) to detect bystanders in the images captured by the device's camera. Such inference models extract various types of information such as distance from the camera, the direction of eye gaze, emotion, and position in the frame (e.g., the center of the frame or not) from the images and use them to improve detection accuracy.

By omitting the need for explicit actions taken by the user/bystander, implicit BPP systems can be easily deployed even when the bystander is unaware of the potential for their information to be recorded and hence promise much wider adoption. However, such systems can potentially suffer poor accuracy in bystander detection when bystanders present themselves in unexpected ways in the captured images. For example, two key features extracted and used in the bystander detection model in such systems are the eye gaze direction of a person in the captured image and being close to the center of the frame than other persons; if a person's eye gaze is towards the device user and/or near the center of the frame, it is likely to be interacting with the device user and hence unlikely to be a bystander. However, as shown in the medical waiting room scenario in FIG. 1, a bystander 109a in the background could be looking at the nurse 103 or might move toward the nurse 103. In this case, existing BPP solutions utilizing the two aforementioned features would erroneously label the bystander 109a as a subject.

In addition to the above detection accuracy limitation, implicit BPP solutions have a second drawback shared with explicit BPP solutions: due to the need for compute-intensive inference models, the implicit solutions are not implemented on resource-constrained devices such as mobile devices. As in explicit BPP systems, they require the raw frames to be recorded and transferred off the device to some centralized server for processing, and hence enlarge the exposure to potential misuse of the bystander data.

In interpersonal communication, a participant is expected to look at her partner more than 60% of the time, with a higher rate of 73% while the participant is listening to her partner speak. This rate can be as high as 88% during a conversation. Interestingly, while speaking, the speaker's eye contact can drop to as low as 41% of the total conversation time. Conversely, for eye contact with strangers or persons with whom one does not intend to speak (who are typically bystanders in an interpersonal interaction), an upper bound may be 3.3 seconds before the eye contact becomes undesirable to the recipient.

Consequently, in an interpersonal interaction using immersive devices such as head-worn AR devices, eye contact of the device user with strangers can be a highly effective indicator or feature in distinguishing the subject from a bystander, because psychologically, the user is likely to make frequent eye contacts with the subject, but unlikely to stare at strangers (who are typically bystanders) for extended periods of time. Further, while the device user's eye gaze may vary across different cultures (e.g., it may occasionally wander off the listener in certain cultures), it is more likely to be directed at the listener while speaking. This suggests that combining the information about the person toward whom the device user's eye gaze is directed and the device user's voice can be a highly effective indicator of whether the person is the subject of the interaction or a bystander.

A straightforward design of a bystander privacy protection (BPP) system that exploits these insights would simply perform the following four basic tasks for every camera-captured frame, to identify the subject and bystanders in the frame: (1) Face detection: identify all the faces in the frame, e.g., using a state-of-the-art face detection model; (2) Eye gaze tracking: track the eye gaze of the device user during the frame interval; (3) Subject identification via face-eye-gaze matching: identify the face in the frame that the user's eye gaze intersects with, and label the face as the subject of the current interaction, and the remaining faces as bystanders; (4) Obscuration of bystanders: obscure the faces of the bystanders in the frame using blurring or other techniques, and export the frame, e.g., recording it in the disk or sending it to a third-party application.

However, the device user's eye gaze may wander off the subject during the interaction. While the device user's eye gaze tends to remain on the subject's face during a personal interaction, it is not 100% of the time. This happens for two possible reasons. First, the user's eye gaze occasionally wandering away from the subject's face is a normal part of human conversations, expected as a way to signal the natural transitions in the conversation. Second, the device user may need to refer to outside aids, such as maps or charts, as part of this interaction. The consequence of this eye gaze wandering behavior is that simply relying on face-eye-gaze matching for each individual frame can misidentify a subject as a bystander (i.e., false negative) and a bystander as a subject (i.e., false positive).

Performing the aforementioned four tasks for every frame on the device may be too costly and infeasible to keep up the frame rate. Face-eye-gaze matching (Task 3) and obscuration of bystander faces (Task 4) tend to be light-weight, and eye gaze tracking (Task 2) comes at almost no cost with hardware support (such as the MICROSOFT HOLOLENS 2). However, identifying faces in a frame (Task 1) generally requires performing face detection inferences, and high-accuracy face detection using deep neural network (DNN) models (e.g., DeepFace) tends to be compute-intensive and incurs a long inference time when running on resource-constrained mobile devices. For example, on-device inference in resource-constrained mobile devices is generally difficult, and in this AR context, negatively impacts the frame rates that are directly correlated with user experience. Even models specifically designed for use on mobile devices can limit frame rates to an unacceptable level. Therefore, various embodiments protect bystander privacy without compromising user experience by maintaining usable frame rates (e.g., near 60 FPS).

Embodiments of the present disclosure are designed to prevent malicious AR applications running on AR devices from collecting sensitive information from visual data of bystanders of interpersonal interactions during the execution of the AR application. Such malicious applications may perform hidden operations that extract sensitive information in bystander visual data captured during AR application execution.

As AR applications, these malicious applications can have full access to AR device cameras, microphones, and network stack after a cursory set of permissions requests, which will be granted by the device user. Embodiments of the present disclosure are designed to prevent malicious activities as well as accidental bystander privacy leaks as well.

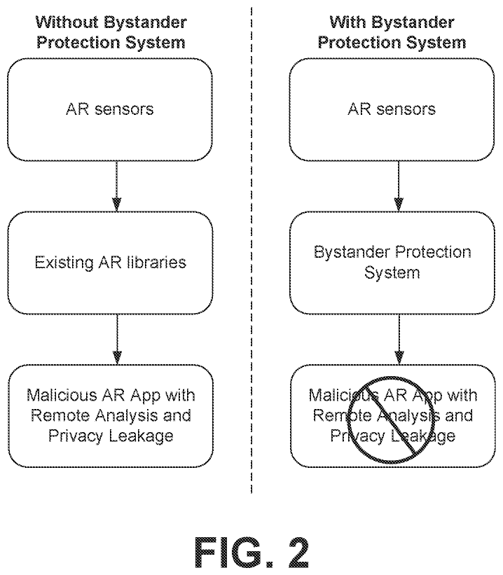

FIG. 2 illustrates this threat. FIG. 2 depicts that a malicious AR application is designed to request bystander visual data from a device, infer sensitive information from this data, and offload the inference results to another location for exploitation. A bystander protection system, shown between the device sensors and the malicious applications in place of the existing AR libraries, is designed to prevent this.

The high-level approach of the bystander protection system to overcome the above threat is to intercept the frame input operations of the application by (1) modifying the operating system's method of allowing access to raw visual data frames, (2) identifying the bystanders/subjects and obscuring bystander faces accordingly, and then (3) passing on the obscured frames to the application. Alternatively, the bystander protection system may be implemented by requesting applications to use special APIs for reading visual data frames. These APIs, which are provided as libraries or a modified framework, implement the above three tasks. During application installation, permissions are given to these special APIs but not the regular APIs for reading visual data frames.

Simply matching the location of detected faces in every frame with the user's eye gaze would disregard the assumption that the user's eye gaze will wander as a natural part of human interaction. When this wandering gaze intersects with a bystander, this bystander could erroneously be labeled a subject and left unprotected in the output frame.

Various embodiments overcome this challenge by collecting data on the history of the user's gaze, as opposed to instantaneous information. The historical information for different persons in these recent frames is used to make a determination of who is the subject in the current frame. Specifically, the identification of the subject/bystander in the current frame is controlled by a threshold. With two input modalities (i.e., eye gaze and voice), the threshold is two-fold. We set a threshold for purely eye gaze contact with a face, as well as one for eye gaze and simultaneous voice contact. Since eye and voice contact is more indicative of human attention, the eye gaze threshold with voice is given a lower value.

These thresholds are the minimum total rate of eye/voice contact over the life of the detection. A range of eye gaze expected in conversations ranges from 41% to 73% and can be as low as 6% when the user is referring to maps, charts, or other visual aids. Additionally, when speaking to a person, eye contact is made less often than when listening to a person speak. The user's eye gaze and voice is treated as a more sure sign of a conversation than purely eye gaze and provide a lower threshold when voice is present.

Algorithm 1 shows the history-based bystander detection algorithm. First, the bystander protection system uses the eye-tracking sensors and wearer-focused microphones present on nearly any modern AR device to log the device user's eye gaze and voice data (Lines 5 and 6). To determine the history of a user's gaze direction, the user's eye gaze and voice contact with a face are tracked (Lines 7-14). Every face detection begins labeled a bystander. If over the life of the detection, the user has made enough contact with the detection to meet the threshold, the face is labeled a subject. If the visual attention of the AR user falls on a detected face initially but wanes afterward, it is possible that the label of subject can revert to bystander if the threshold for contact is no longer met.

Algorithm 1 BYSTANDAR Control Loop

```
  1: Parameters: N sampling interval
  2: FrameCounter = 0
  3: while True do
  4: Increment FrameCounter
  5: Compute the current location of the eye gaze
  6: Monitor if voice input is above noise floor
  7: if Eye-gaze/Voice intersects with a face then
  8: Increment eye/voice tracker for face
  9: if Eye-gaze/Voice history > Threshold then
10: Label face a subject
11: else
12: Label becomes/remains bystander
13: end if
14: end if
15: if FrameCounter ≥ N then
16: FrameCounter = 0
17: Retrieve raw depth and camera frames
18: Infer location of all faces in frame
19: for each Face detected do
20: Transform 2D detection to 3D world space
21: if face overlaps with an existing face then
22: Replace current detection; reset TTL
23: else
24: Create new detection
25: end if
26: if Application requesting sensor data then
27: Obscure bystander faces in frame
28: end if
29: end for
30: else
31: if Application requesting sensor data then
32: Obscure bystander faces in frame
33: end if
34: end if
35: Release frames to application
36: end while
```

The history-based bystander detection method described above still assumes performing face detection on every camera frame. Performing face detection on every frame may be too costly on mobile devices and may not be able to keep up with the high frame rate (e.g., near 60 FPS) needed to support a high quality of user experience (QoE). To overcome this challenge, various embodiments avoid performing face detection on every frame.

If during an interpersonal interaction, the AR device does not move, consecutive frames captured by the camera would have the same spatial frame of reference, every N frames for face detection could be skipped in the above history-based algorithm, and the algorithm would still be able to successfully match faces with the user's eye gaze and voice. One challenge is that the history of eye-gaze and voice information needs to be accumulated for the same person across frames, but the faces (of bystanders or the subject) may move across frames. Thus, movement should be tracked so that it can be determined that faces in different frames correspond to the same person. This could be achieved by lightweight motion tracking techniques such as optical flow.

The above frame-skipping scheme, however, does not handle the movement of the device itself, which can happen often in interpersonal interactions as the user moves her head around and changes the spatial frame of reference of consecutive frames, which makes it much harder to match faces in different frames to the same person. To tackle this challenge, one of the capabilities of AR devices is Simultaneous Localization and Mapping (SLAM), the foundation of the device's spatial awareness, which can be used to track the location of a detected face when the device moves. This AR device capability can be used to omit face detection. To do this, the time required for a face to move outside of a face detection's bounding box may be estimated. From this, then the number of subsequent frames N during which the faces will remain in the same bounding box can be estimated, and face detection can be skipped for these N frames. During the capture of these subsequent N frames, it is assumed that the face will remain inside its previous bounding box, removing the need for per-frame detection. In other words, AR devices can track faces in 3D positions over time, which relieves the requirement to perform face detection more often than the device can support.

Using Algorithm 1, if a frame is selected for inference at the interval N, the frame is captured (Line 17). The location of each face in the captured frame is then inferred (Line 18). Each face detected in this frame is located using an absolute spatial reference, called a world coordinate system or world space in AR. By doing so, the face can be accounted for as the user moves, even when this motion causes the face to move completely out of the next camera frame. The method provided by AR cameras to convert a 2D point (e.g., that of a face detected in the 2D frame) to the 3D world space can be used (Line 20). If a face overlaps with a previous detection, indicating that the face has moved, the location of the face is updated. In this way, face movement is tracked (Lines 21-25). To prevent stale faces, if the face has not been updated in a given Time-to-Live (TTL) window, the face is removed (Line 22).

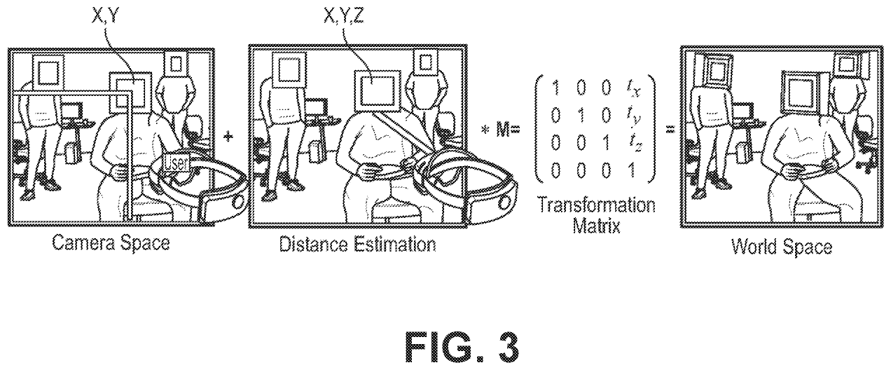

FIG. 3 presents an illustration of this process. FIG. 3 shows an illustration of the 2D-to-3D camera-to-world transformation process. Here, matrix M is an arbitrary transformation matrix created from the metadata included with each captured frame; it is used to convert 3D points in camera space to world space.

Any usable solution to increase bystander expectations of privacy, should allow third-party applications access to any obscured frames. In the final step, the bystander protection system performs obscuration of the faces of detected bystanders in every frame and its corresponding depth frame, before passing them to the requesting AR applications (Lines 31 and 32).

Specifically, every frame is compared against existing, detected faces for potential obscuration to ensure bystander privacy as follows. As each new frame is captured and presented to the bystander protection system, the system detects the faces in it. The bystander protection system converts the 3D location of any face in the field of view (FOV) of the camera to a 2D position relative to the camera's current frame. If the detection has been labeled a subject and the user is making eye contact, nothing is done. If the detection has been labeled a bystander or is a subject not currently under the user's attention, the bystander is obscured in two ways. The visual data from the camera frame is obscured to protect the bystander's face, informed by the original bounding box in the detection. The detection is then translated to the FOV and local coordinate system of the depth camera to inform the obscuration of this depth frame as well.

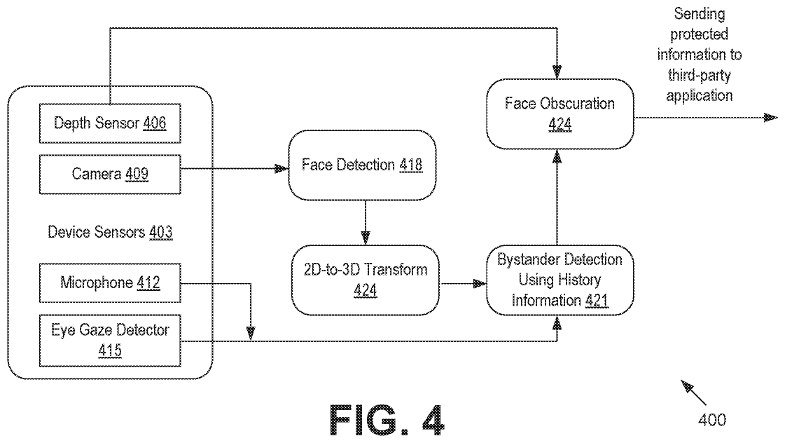

FIG. 4 illustrates an example architecture for the bystander protection system 400 according to one or more embodiments. The AR device sensors 403 may include one or more depth sensors 406, one or more cameras 409, one or more microphones 412, and one or more eye gaze detectors 415. Raw data is captured from the device's sensors and is used both in face detection 418 and learning eye gaze and voice history information for bystander detection 421. Afterward, bystander detection is used to obscure human faces not designated subjects in both camera and depth frame data in face obscuration 424.

The camera and depth frames are continuously captured by the AR device camera 409 and the depth sensor 406. At a given sampling interval, the face detection 418 module infers the 2D location of any faces present in the frame, and the bystander protection system 400 locates these faces in 3D after 2D-to-3D transformation 424. Using this location, we create a 3D bounding box, invisible to the user, that serves as the 3D anchor for each detection. By default, these faces are labeled bystanders. As sampled face detection 418 continues and the position of the face changes, the bystander protection system 400 updates the location of the face and moves the 3D bounding box accordingly. In parallel with the above face detection 418 and tracking process, the bystander protection system 400 collects information about the user's eye gaze and voice using the AR device's onboard eye gaze detector 415 and wearer-focused microphone 412. For every camera frame, the bystander protection system 400 tracks on which face the user's attention is currently focused and maintains a history of this information for all currently detected faces. Once the history of the user's attention (eye gaze or simultaneous eye gaze and voice input) meets a pre-specified threshold, the detection is labeled a subject by the bystander detection using history information 421. With this context, the face obscuration 424 module obscures the faces of each detection as required. After bystander visual data has been removed from each frame, the frame is safe for release to any third-party application.

A prototype implementation of the bystander protection system according to one embodiment is next described. In one implementation, the bystander protection system is built in UNITY using the MICROSOFT MIXED REALITY TOOLKIT (MRTK) version 2.7.2, and the bystander protection system is deployed on a MICROSOFT HOLOLENS 2 device running WINDOWS HOLOGRAPHIC FOR BUSINESS. MICROSOFT's “MediaCapture” class may be used to capture camera and depth frames, as well as collect the tranformation matrices required for the 2D-to-3D detection conversion. The “FaceDetector” class of MICROSOFT's “FaceAnalysis” namespace is used for the face detection. A sampling rate of every 8 frames may be used, informed by pilot testing and determined to be a good balance of accuracy and device resource load. Camera frames are collected with an input resolution of 1290×1080 pixels, a parameter determined in pilot testing to be a balance of inference accuracy and latency. The implementation is tested two differing threshold levels. One, designed to test the higher limits of expected human eye/voice contact, sets a minimum of 50% pure eye contact or 25% simultaneous eye gaze and voice contact over the life of the detection. A lower threshold, 25% and 15%, respectively, was designed to test the lower bound of expected contact.

For the obscuration of the frame, a complete mask of the camera frame is used informed by the face detection's bounding box. The complete masking, as opposed to blurring, is because deblurring of such an image is indeed possible. Unique to the depth obscuration, the bit values of the raw depth data are not simply changed to create a mask, but the existing data is plateaued to keep from creating “depth holes” in the image. Instead of completely masking the depth area, the faces of bystanders are smoothed over using the depth at the edges of the detection as a reference. This keeps from creating “depth holes” artificially. Depth holes create inconsistencies that can hamper the AR user experience. If using the depth frame, knowledge of the presence of the face is still kept, but the details and potentially uniquely identifying contours of the face are removed. The onboard eye gaze tracking, wearer-focused microphone, and built-in spatial awareness of the HOLOLENS 2 can be used to accomplish these tasks through the MRTK.

In another embodiment, faces of bystanders may be masked using, for example, an emoji or other indicium that may convey some information about the bystander. For example, an emoji mask may convey a detected emotion associated with the bystander. In other words, the emotion of the bystander may be preserved, though the identity of the bystander is masked. In other scenarios, various inferred information about bystanders may be preserved for use by other applications, while information about the identities of the bystanders are protected.

In another embodiment, masking of persons may be performed based at least in part on an identified age. For example, the faces of all persons or bystanders who are determined to be under a certain age (e.g., under 18) may be masked or obscured, while the faces of persons or bystanders above the age may be unobscured.

In some cases, the original unmasked video and depth data may be preserved in a protected format. For example, the original data may be encrypted and protected from access by third-party applications on the AR device.

In addition to visual and depth masking, the voices of the bystanders may be isolated from the audio and muted within the audio before the audio is provided to another application. For example, each of the voices may be profiled and associated to particular faces identified as bystanders or subjects, and speech associated with a voice profile may be muted. In the case of a transcription, speech recognized from bystander voices may be deleted from a transcription.

In some embodiments, an analysis may be performed on faces detected in the visual data to determine a direction at which the faces are looking. This analysis may consider the direction of the face as well as eye contact. If a face looks in the direction of the AR user (i.e., the face and corresponding eyes are looking toward the camera of the AR device), the face may be more likely to be a subject and not a bystander. Accordingly, a combination of other factors (i.e., eye gaze history, voice history) along with the eye contact of the face may meet a lesser threshold for classification as a subject. If mutual eye contact is established between the user of the AR device (i.e., using eye gaze tracking) and the person represented by the face, the mutual eye contact may have a greater weight in classifying the face as being a subject rather than a bystander.

In addition, if a microphone array can localize a particular face as speaking in a conversation with the user of the AR device, the determined conversation between the person represented by the face and the user of the AR device may weigh toward classifying the face as being a subject and not a bystander.

In some cases, thermal data may be captured by an infrared sensor on the AR device. The thermal data associated with identified bystanders may be masked or obscured according to the same techniques used for visual or depth masking.

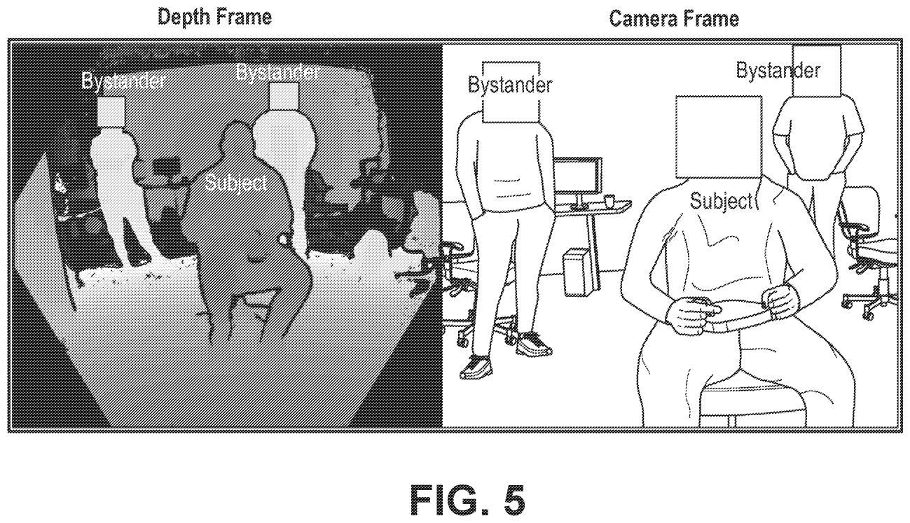

FIG. 5 is an illustration of the output of one implementation of the bystander protection system if a third-party application is requesting visual data. The face of the subject is blurred only to protect the participant's identity, and there would not be such blurring in actual output. Note that the “boxes” over the face of the bystanders in the depth data reflect the depth of the bystander themselves in a plateauing manner.

An example evaluation of one implementation of the bystander protection system is next described. The example evaluation includes sixteen participants, and is designed to not only test the effectiveness of the bystander protection system (i.e., the ability of the bystander protection system to differentiate subject from bystander), but also to evaluate performance when implemented on a MICROSOFT HOLOLENS 2. The effectiveness of the bystander protection system is determined by evaluating the success rates of the prototype, defined as the amount of correctly obscured faces compared to the total number of detected faces corresponding to bystanders in every frame. The performance of our prototype is evaluated by measuring frame rate, which is compared with the minimum frame rate for preserving user experience recommended by the device manufacturer.

Prior to testing, each user was given a 10-minute tutorial on AR gestures, specific to the MICROSOFT HOLOLENS 2, and given instructions on fitting and operating the device. Additionally, each user was instructed to complete an eye gaze calibration using MICROSOFT's onboard calibration application.

For each test, the prototype was running and obscuring every captured raw frame. For evaluation, the prototype was designed to offload every 10th obscured frame. This is separate from the inference sampling interval and was used to capture obfuscated data for evaluation. During pilot testing, offloading at higher rates increased the resource load on the device and reduced the frame rate to unusable levels. Every 10th frame was sampled to strike a balance between capturing as many frames as possible for evaluation and the impact on the device. Additionally, the offload interval was deliberately offset from the inference sampling interval (every eight frames) to ensure that frames selected to be offloaded were collected at varying times from the previous inference.

The sixteen participants were grouped into sessions that contain one user, one subject, and between one to three bystanders. A study protocol was created with one participant (i.e., user) wearing the AR device while interacting with a partner (i.e., subject) not wearing a device. During this test, the AR user was instructed to ask questions of the partner seated approximately 2 meters from them, for a total of 3 minutes. The AR user then swapped roles with their partner by giving them the AR headset and repeating the test.

The data collection sessions were divided into two groups in order to test two eye gaze and voice thresholds. Group 1 used a gaze threshold of 50% contact over the life of the face detection. Since eye gaze and voice have a stronger correlation with user's attention, a lower threshold of 30% to eye gaze contact was given when the AR user is speaking. Group 2 had these thresholds set to 25% and 15%, respectively, to explore a shorter duration for subject detection.

For each obscured frame, the effectiveness of the bystander protection system is analyzed by using DEEPFACE, an open-source facial analysis tool, to evaluate the bystander protection system's ability to identify subject/bystanders, and when necessary, protect them. Any bystander face found by DEEPFACE in the obscured frame indicated a failure of our system. In this experiment, a confidence threshold of 90% was used for DEEPFACE detections. The total quantity of obscured bystander faces compared to the total quantity of detected bystander faces is computed as the bystander protection rate.

Each frame is analyzed to quantify the prototype's effectiveness in determining the subject of the interaction. Knowing the identity of the intended subject, every frame and record are inspected to determine the face of the subject was unobscured. If the eye gaze of the AR device user was directed at the face of the subject, the face of the subject is expected to be unobscured. If the eye gaze is directed at the subject and the face remains obscured, this is considered a failure. The number of subject faces properly unobscured compared to the total number of subject faces is computed as the subject availability rate.

Finally, in order to measure performance (in terms of frame rate), the FPS of the prototype is calculated as it runs on the MICROSOFT HOLOLENS 2. Each FPS calculation is done over a testing period of 3 minutes. The test is performed twice, once with the prototype configured as if it was required to release obscured frames to a third-party application, and another without releasing frames. In both test cases, the prototype is collecting raw images, inferring the location of faces in 2D, creating 3D face detections, and collecting eye gaze and voice data to determine if the faces are subjects.

The bystander protection system is evaluated, using eye gaze and voice data from the user, protects bystanders from DEEPFACE face detection on frames captured by the HOLOLENS 2's onboard camera. The two groups of eye gaze and simultaneous eye gaze and voice thresholds are compared, Group 1 (50% gaze and 30% gaze/voice) and Group 2 (25% gaze and 15% gaze/voice), to determine which is ideal for effectiveness.

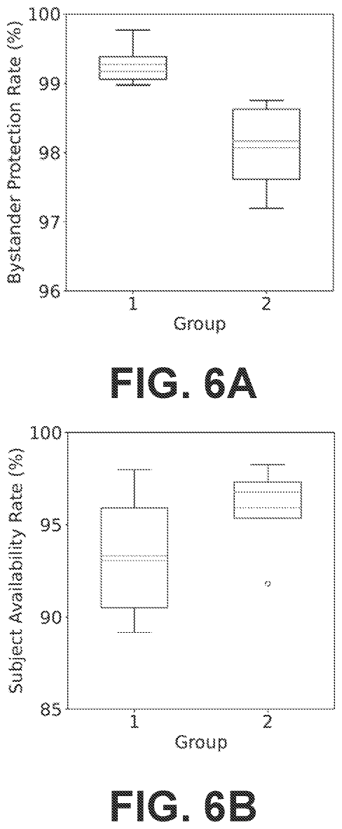

FIGS. 6A and 6B illustrate the tradeoff in bystander privacy protection between the two groups of eye gaze and voice thresholds. Lower thresholds result in lower rates of bystander privacy protection but a higher subject availability rate. Specifically, as shown in FIG. 6A, the impact of a lower threshold on bystander protection rate is marginal (about 1%), and bystander protection rates of both two threshold options were high (99.32% and 98.14% for Groups 1 and 2, respectively). In terms of subject availability rate, as shown in FIG. 6B, the lower thresholds can improve it by about 2.6%, from 93.63% to 96.27%. In the example implementation, the lower thresholds (used in Group 2) are used as the default option since the lower thresholds provide a more balanced performance for both subject and bystanders.

The bystander protection system also provides bystander protection on depth frames. For each frame, using the established face detections and their label as a “bystander” or a “subject,” faces are obscured using a depth mask that is the same as the depth levels surrounding the detection. This provides the plateau effect mentioned above. While the HOLOLENS 2's depth data was insufficiently detailed to use existing depth-based face detection methods, every depth frame was obscured in the same way as its camera counterpart.

Between Group 1 and Group 2 thresholds, comparable bystander protection rates were achieved, with a 2.6% improvement in subject availability rates. The following evaluations of the example of the bystander protection system were performed using gaze and simultaneous gaze and voice thresholds of 25% and 15%, respectively.

The bystander protection rate may be compared between the example implementation of the bystander protection system running in real time and a highly accurate offline bystander detection model. The offline approach extracts features from each face and classifies them as bystander or subject with up to 94.3% accuracy using a Gradient Boosted Decision Tree (GBDT). The extracted features capture 3D head pose, the angle between gaze direction and the camera, if the face was out of focus, and distance from the camera. The offline approach processed every frame and could not feasibly be implemented on an AR device in real time.

Visual data from three additional scenarios were collected for a robust comparison: a single bystander with no subject, a subject with static bystanders, and a subject with bystanders that include movement. The identified bystanders were positioned on either side of the subject and both in front of or behind them for 60 seconds at a time while camera frames from the bystander protection system were recorded. Raw frames were also recorded for input to the offline model. Each of the recording scenarios lasted for two minutes in total.

Table 1 presents the bystander protection rates between the bystander protection system prototype implementation and the GBDT offline approach. The prototype implementation of the bystander protection system performed better overall, with an overall rate of 94.1% compared to 82.3%. In the “No Subject” scenario, one individual was present but did not interact with the AR user. In this scenario, the bystander protection system had a perfect protection rate of 100%, while the GDBT model classified the face as a subject in every frame, producing a protection rate of 0%. The bystander protection system detects the subject based on eye gaze and voice interaction and does not suffer any false classification as a result. Accurate bystander recognition is important in the absence of a subject, as this is a typical scenario for AR users on a daily basis.

For scenarios that include a subject and multiple bystanders, both the bystander protection system and the GBDT model performed worse with a moving bystander. While the bystander protection system had a 2% higher protection rate with static bystanders, the GDBT model had a 3.3% higher rate with a moving bystander. Rates from these two scenarios show that a moving bystander is more difficult to identify and obscure, and an offline model applied to every frame is only marginally better than the example implementation of the bystander protection system running in real time with an inference sampling interval of eight frames.

TABLE 1

| | GBDT[14] | BYSTANDAR |
|---|---|---|
| Scenario | Protection Rate | Protection Rate |
| No Subject | 0% | 100% |
| Static Bystanders | 95.3% | 97.3% |
| Moving Bystander | 91.6% | 88.3% |
| Overall | 82.3% | 94.1% |

As seen in Table 1, the effectiveness of the example implementation of the bystander protection system can vary based on the characteristics of bystanders. The impact of different numbers of bystanders in the scene and where motion degrades protection rates are evaluated. The bystander protection rates across sessions with one, two, and three bystanders were computed from the procedure described above. Average protection rates were the highest for three bystanders (99.26%), the median for two bystanders (98.74%), and the lowest for one bystander (98.30%). Overall, increasing numbers of bystanders had a negligible impact on bystander protection.

Next, results from the evaluation of the bystander protection system are evaluated temporally based on the motion level of bystanders. Data collection sessions where the bystander(s) made large movements are identified, defined as movements from one side of the user's FOV to the other. In the tests with this motion, the bystander protection system protected the visual data of bystanders in 98.91% of frames. For tests where the bystanders remained static, a protection rate of 98.77% was achieved.

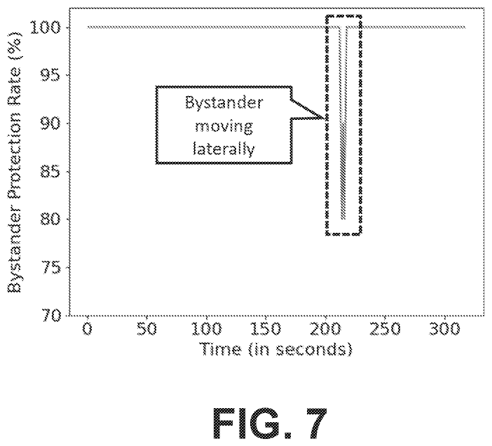

FIG. 7 illustrates bystander protection rates of the example implementation of the bystander protection system over a 10-second average. The inset box highlights a drop in protection rates during large bystander movement. While the rates drop for a few frames, overall performance is maintained for a majority of data. Additionally, FIG. 7 shows a single test run and the impact that dramatic bystander movement had on the protection rate. Both the figure and the aggregate results show the minimal impact bystander movement had during our testing. Situations where this result may differ are discussed below.

Using an inference sampling interval of eight frames, the example implementation of the bystander protection system being tested runs at 52.6 FPS while not being required to obscure frames for release to a third-party application. In fact, this method is likely to be the most widely used if the device is not running an application that requires camera or depth frames. In this mode, the bystander protection system still collects raw images and obscures faces according to the bystander/subject detection described above. It does not, however, apply any masks to any output images. This frame rate is comparable to the HOLOLENS 2's recommended 60 FPS (when not capturing media frames) as suggested by MICROSOFT. When the prototype is configured to release obscured frames, the bystander protection system achieves 33.6 FPS. Such a drop in frame rate is expected for this example prototype, as MICROSOFT's standard sensor data logging API states that frame rates will drop to around 30 FPS. The bystander protection system would switch between offloading frames and not based on whether a third-party application was requesting them.

To stress test the bystander protection system, tests were executed using an inference sampling interval of one frame, meaning every captured camera frame was used for inference. While not obscuring frames (i.e., simulating running while no third-party application is requesting frames), the prototype runs at 15.2 FPS, but while obscuring frames, the prototype runs at 11.5 FPS. This significant drop shows the problems with per-frame inference as both values are well below any thresholds recommended by MICROSOFT for usable frame rates as a result of inferring on every frame.

Finally, Table 2 shows a breakdown of the impacts of the bystander protection system on the system resources of the HOLOLENS 2, as compared to the device's idle load. As a third-party application, the bystander protection system increases the processor load on the HOLOLENS 2 by 27%, with minimal increases in memory footprint and power consumption. These requirements may diminish with the bystander protection system being implemented at the operating system level.

TABLE 2

| | Avg. | Avg. | | |
|---|---|---|---|---|
| Total System | CPU | GPU | System | Power |
| Load | Usage | Usage | Memory | Util. |
| w/BYSTANDAR | 72% | 0% | 2.8 GB | 68% |
| System Idle | 45% | 0% | 2.2 GB | 61% |

In the current demonstration prototype, the bystander protection system is implemented as a third-party application running on the Microsoft HoloLens 2's Windows Holographic OS. On the HoloLens 2, only one AR application is allowed to run at a time. The bystander protection system cannot intercept and obscure frames as a sole third-party application. An assumption stated in multiple areas of this work is that, if ever implemented on a production system, the bystander protection system may be implemented at the OS level. This could add challenges, such as how and when to update inference models used by core OS processes. This also provides some advantages for efficiency, as toolkits and APIs such as MRTK might not be necessary.

With the bystander protection system obscuring visual data of bystanders, questions may arise concerning the ability of the device to conduct the Simultaneous Localization and Mapping (SLAM) that allows for spatial awareness and is crucial to the device's function. The bystander protection system does not obscure the data from the HOLOLENS 2's four Visual Light Cameras (VLCs) that serve this purpose. This data can only be accessed by using the HOLOLENS 2's research mode, something not allowed on applications seeking to be published widely. In fact, users must explicitly allow the use of research mode data in a special area of the HOLOLENS 2's developer settings.

As part of our testing design, the effectiveness of the bystander protection system was evaluated if the subject was also an AR device user. For this, a second test was created that uses MICROSOFT's AZURE Spatial Anchors to share an absolute understanding of a physical space. The users were required to collaborate by building a block structure while the application synchronized the location of their blocks on a cloud game server. The chosen model, FACEDETECTOR, proved to be unreliable when detecting the faces of “subjects” wearing AR devices, but just as reliable for device-less bystanders as expected. Models such as these can be retrained to identify faces with AR devices.

The prototype was modified to use the location of the subject, tracked using the spatial anchor, to improve the tracking of the subject forcing the user to report the world space location of their device. This allowed the user to be identified in 3D, even without face detection. Success was achieved with this method compared to the single-user scenario, effectively placing a face detection object over the self-reported location of the subject's headset that reacts to eye gaze and voice as any other would. Success is defined as protection/availability rates comparable to the one-user scenario.

In the bystander protection system, a per-frame inference is not necessary to create a reliable system. This is grounded in the fact that face movement, like movement in all media capture, is replicated with a series of frames giving the illusion of actual movement. Faces, people, things, etc., are not “moving” in videos, they are merely shifting in relative position across every frame. If the inference rate is fast enough, the bystander/subject face cannot move outside of the obscuration between inferences. However, at a frame rate of 52 FPS and an inference sampling interval of eight, like the bystander detection system, an inference occurs about every 154 milliseconds. Given an average face width of 0.15 meters, a face at the center of an obscuration box must move 0.15 meters in 154 milliseconds to evade the box and be fully revealed, which leads to the following speed: 0.97 meters per second. Given this speed, a face could elude the inference rate and be unprotected. Even in testing, of the small number of bystander faces exposed, about 50% were due to movement. This can be ameliorated through more rapid inference at the cost of lower frame rates. More advanced and powerful AR devices can allow more rapid inference with less, if any, frame rate degradation.

The bystander protection system may be built with the natural dynamics of human eye and voice contact in mind. Given the social barriers to staring at persons not part of an interaction, the risk of users unintentionally staring at the exposed face of a bystander is possible but limited. However, if the user intends to expose the face of a bystander without them being part of an AR interaction, they can certainly choose to keep eye contact on an exposed face to prevent obscuration by the system. This would override the assumptions made about normal human eye and voice contact. It would also be noticeable to the bystander and other parties that a person not involved in an interaction or conversation was staring at a seemingly random person.

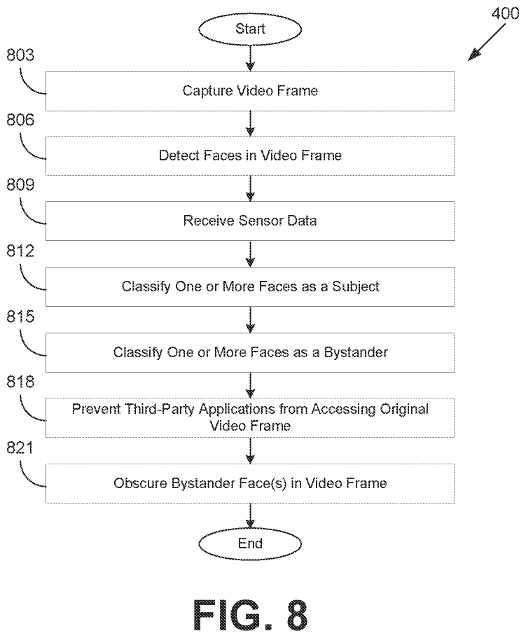

Referring next to FIG. 8, shown is a flowchart that provides one example of the operation of a portion of a bystander protection system 400 according to various embodiments. It is understood that the flowchart of FIG. 8 provides merely an example of the many different types of functional arrangements that may be employed to implement the operation of the portion of the bystander protection system 400 as described herein. As an alternative, the flowchart of FIG. 8 may be viewed as depicting an example of elements of a computer-implemented method according to one or more embodiments.

Beginning with box 803, the bystander protection system 400 captures a video frame using one or more cameras 409 of a wearable AR device. In box 806, the bystander protection system 400 performs face detection 418 on the video frame to detect one or more faces in the video frame. For example, the bystander protection system 400 may determine a respective three-dimensional bounding box around individual faces. The bounding boxes may be used for tracking movements of the faces in subsequent video frames. In box 809, the bystander protection system 400 receives sensor data from the device sensors 403, which may include data from the depth sensor 409, sound captured by the microphone 412, and eye gaze information from the eye gaze detector 415.

In box 812, the bystander protection system 400 classifies one or more of the detected faces as a subject. The face(s) may be classified as a subject based at least in part on eye gaze tracking of the user of the wearable AR device by an eye gaze sensor of the wearable AR device. The classification may be further based at least in part on an eye gaze history of the user directed at the subject face meeting a threshold. In some embodiments, the face(s) may be classified as a subject based at least in part on the audio captured by the microphone 412, which may be correlated with the faces to ascertain whether the user is speaking. In some embodiments, classifying the face(s) as the subject may be further based at least in part on an eye gaze history of the user directed at the face(s) and a simultaneous voice contact of the user meeting a first threshold, where the first threshold is lower than a second threshold associated with the eye gaze history but not the simultaneous voice contact.

In box 815, the bystander protection system 400 classifies one or more of the detected faces as a bystander. The face(s) may be classified as a bystander based at least in part on eye gaze tracking of the user of the wearable AR device by an eye gaze sensor of the wearable AR device. The classification may be further based at least in part on an eye gaze history of the user directed at the bystander face not meeting a threshold. In some embodiments, the face(s) may be classified as a bystander based at least in part on the audio captured by the microphone 412, which may be correlated with the faces to ascertain whether the user is speaking.

In box 818, the bystander protection system 400 prevents third-party applications from accessing the original video frame before obscuration of bystanders. In box 821, the bystander protection system 400 performs face obscuration 424 to obscure the faces of any bystanders detected in the video frame. The obscuration may include obscuring the bystander faces in corresponding depth data based at least in part on plateauing the corresponding depth data using a depth value from an edge of an area including the bystander face. The obscuration may include completely masking an area of the video frame surrounding a respective bystander face.

Subsequently, the video frame where the bystander face(s) are obscured may be released to an application requesting the video frame. Also, as interactions continue, the subject face may be reclassified as a bystander face in a subsequent video frame based at least in part on eye gaze tracking relative to the subsequent video frame. Similarly, the bystander face may be reclassified as a subject face in a subsequent video frame based at least in part on eye gaze tracking relative to the subsequent video frame. Thereafter, the operation of the portion of the bystander protection system 400 ends.

The embodiments can be embodied or implemented in hardware, software, or a combination of hardware and software. If implemented in hardware, the embodiments can include at least one processing circuit, with at least one storage or memory device. The at least one processing circuit can include, for example, one or more processors and one or more storage or memory devices coupled to a local interface. The local interface can include, for example, a data bus with an accompanying address/control bus or any other suitable bus structure. The storage or memory device can store data or components that are executable by the processors of the processing circuit.

In another example, if implemented in hardware, the embodiments can include as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, and/or programmable logic devices (e.g., field-programmable gate array (FPGAs), and complex programmable logic devices (CPLDs)).

If implemented in software, each step or element can represent a module or group of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system.

The flowchart of FIG. 8 shows the functionality and operation of an implementation of portions of a bystander protection system 400. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart of FIG. 8 shows a specific order of execution, it is understood that the order of execution may differ from that which is depicted. For example, the order of execution of two or more blocks may be scrambled relative to the order shown. Also, two or more blocks shown in succession in FIG. 8 may be executed concurrently or with partial concurrence. Further, in some embodiments, one or more of the blocks shown in FIG. 8 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, one or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Further, any logic or applications described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices. Additionally, terms such as “application,” “service,” “system,” “engine,” “module,” and so on can be used interchangeably and are not intended to be limiting.

1. A computer-implemented method for protecting bystander privacy in a wearable augmented reality (AR) device, the method comprising:
capturing a video frame via a camera of the wearable AR device;
detecting a plurality of faces in the video frame;
classifying a first face of the plurality of faces as a subject based at least in part on eye gaze tracking of a user of the wearable AR device by an eye gaze sensor of the wearable AR device;
classifying a second face of the plurality of faces as a bystander based at least in part on the eye gaze tracking of the user; and
obscuring the second face in the video frame in response to the second face being classified as the bystander.

2. The computer-implemented method of claim 1, further comprising releasing the video frame where the second face is obscured to an application requesting the video frame.

3. The computer-implemented method of claim 1, further comprising:
capturing audio via a microphone array of the wearable AR device;
determining whether the audio indicates that the user is speaking;
wherein the first face is classified as the subject further based at least in part on whether the audio indicates that the user is speaking; and
wherein the second face is classified as the bystander further based at least in part on whether the user is speaking.

4. The computer-implemented method of claim 1, wherein classifying the first face as the subject is further based at least in part on an eye gaze history of the user directed at the first face meeting a threshold.

5. The computer-implemented method of claim 1, wherein classifying the second face as the bystander is further based at least in part on an eye gaze history of the user directed at the second face not meeting a threshold.

6. The computer-implemented method of claim 1, further comprising preventing an application executed in the wearable AR device from accessing the video frame prior to obscuring the second face in the video frame.

7. The computer-implemented method of claim 1, wherein classifying the first face as the subject is further based at least in part on an eye gaze history of the user directed at the first face and a simultaneous voice contact of the user meeting a first threshold, the first threshold being lower than a second threshold associated with the eye gaze history but not the simultaneous voice contact.

8. The computer-implemented method of claim 1, further comprising reclassifying the first face as the bystander in a subsequent video frame based at least in part on the eye gaze tracking relative to the subsequent video frame.

9. The computer-implemented method of claim 1, further comprising reclassifying the second face as the subject in a subsequent video frame based at least in part on the eye gaze tracking relative to the subsequent video frame.

10. The computer-implemented method of claim 1, wherein detecting the plurality of faces in the video frame further comprises determining a respective three-dimensional bounding box around individual ones of the plurality of faces.

11. The computer-implemented method of claim 10, further comprising tracking movement of the plurality of faces in a subsequent video frame based at least in part on the respective three-dimensional bounding box around the individual ones of the plurality of faces.

12. The computer-implemented method of claim 1, wherein obscuring the second face in the video frame further comprises obscuring the second face in corresponding depth data based at least in part on plateauing the corresponding depth data using a depth value from an edge of an area including the second face.

13. The computer-implemented method of claim 1, wherein obscuring the second face in the video frame further comprises completely masking an area of the video frame surrounding the second face.

14. A wearable augmented reality (AR) device, comprising:
a camera;
an eye gaze sensor; and
a processor configured to at least:
capture a video frame via the camera;
detect a plurality of faces in the video frame:
classify a first face of the plurality of faces as a subject based at least in part on eye gaze tracking of a user of the wearable AR device by the eye gaze sensor;
classify a second face of the plurality of faces as a bystander based at least in part on the eye gaze tracking of the user; and
obscure the second face in the video frame in response to the second face being classified as the bystander.

15. The wearable AR device of claim 14, further comprising a microphone, wherein the processor is further configured to at least:
capture audio associated with the video frame via the microphone;
detect a voice in the audio; and
classify the first face as the subject based at least in part on the voice detected in the audio.

16. The wearable AR device of claim 14, wherein the processor is further configured to at least:
prevent an application from accessing the video frame before the second face has been obscured; and
release the video frame to the application after the second face has been obscured.

17. The wearable AR device of claim 14, wherein the first face is classified as the subject in response to an eye gaze history of the user directed at the first face meeting a first threshold, and the second face is classified as the bystander in response to the eye gaze history of the user directed at the second face not meeting the first threshold and not meeting a second threshold that is lower than the first threshold, the second threshold being evaluated relative to a combination of the eye gaze history of the user and a voice interaction history of the user.

18. The wearable AR device of claim 14, wherein the processor is further configured to at least obscure the second face in corresponding depth data based at least in part on plateauing the corresponding depth data using a depth value from an edge of an area including the second face.

19. The wearable AR device of claim 14, wherein the processor is further configured to at least track movement of the plurality of faces in a subsequent video frame based at least in part on a respective three-dimensional bounding box around individual ones of the plurality of faces.

20. A non-transitory computer-readable medium embodying instructions executable in a processor of a wearable augmented reality (AR) device, wherein when executed the instructions cause the processor to at least:
capture a video frame via a camera of the wearable AR device;
detect a plurality of faces in the video frame;
classify a first face of the plurality of faces as a subject based at least in part on eye gaze tracking of a user of the wearable AR device by an eye gaze sensor of the wearable AR device;
classify a second face of the plurality of faces as a bystander based at least in part on the eye gaze tracking of the user; and
obscure the second face in the video frame in response to the second face being classified as the bystander.
